(19) United States
(12) Patent Application Publication
(10) Pub. No.: US 2006/0114210 A1
(43) Pub. Date: Jun. 1, 2006

(54) POWER SAVING FLAT TYPE DISPLAY AND METHOD THEREOF

(76) Inventors: Jung-Zone CHEN, Tainan County (TW); Lin-Kai BU, Tai-Nan County (TW); Ying-Lieh CHEN, Tainan County (TW)

Correspondence Address: NORTH AMERICA INTELLECTUAL PROPERTY CORPORATION, P.O. BOX 506, MERRIFIELD, VA, 22116, US

(21) Appl. No.: 10/906,359

(22) Filed: Feb. 16, 2005

(30) Foreign Application Priority Data
Nov. 30, 2004 (TW) 093136897

(51) Int. Cl. G09G 3/36

(52) U.S. Cl. 345/98

(57) ABSTRACT

A flat type display and method thereof capable of reducing power consumption includes a plurality of shift registers for temporarily storing digital image data, and a plurality of mode-selecting units for determining the shift registers not storing digital data, and then turning off corresponding output operational buffers based on the image resolution. Utilizing such flat type display and method, the power consumption of the flat type display is reduced due to the turning off of selected output operational buffers of the flat type display.

### BACKGROUND OF INVENTION

1. Field of the Invention

The present invention relates to a flat type display, and more particularly, to a flat type display capable of reducing power consumption.

2. Description of the Prior Art

Liquid crystal displays (LCDs) have been most widely utilized in mobile displays as a replacment for the Cathode Ray Tube (CRT), due to features of excellent picture quality, lightweight, thin size, and low power consumption.

Please refer to FIG. 1, showing a functional block diagram of a conventional LCD display 10. The LCD display 10 comprises an LCD panel 12, a plurality of data line drivers 14 coupled to the LCD panel 12, and a plurality of scan line drivers 18 coupled to the LCD panel 12. The LCD panel 12 comprises a plurality of pixel units 20 each having a transistor 22 and a storage capacitor Cs. A plurality of scan lines 24 and a plurality of data lines 26 respectively are coupled to the scan line driver 18 and the data line driver 14.

Please refer to FIGS. 1 through 3. FIG. 2 is a functional block diagram of the LCD driver 14 illustrated in FIG. 1. FIG. 3 is a circuit diagram of an operational amplifier buffer. The data line driver 14 comprises a shift register 32, a latch 34, a plurality of digital-to-analog converters (DACs) 36, and a plurality of operational amplifier buffers (OP buffers) 38. The digital image data from serial input ends 25 are serially fed into the shift register 32. In general, a digital image data in a format of 6 bits indicates a brightness value of a pixel unit 20. After the shift registers 32 are filled with the digital image data, the latch 34 simultaneously outputs the digital image data to the DAC 36 to complete a serial-in parallel-out transmission. Next, the operational amplifier buffer (OP buffer) 38 buffers analog voltage that is transformed by the DAC 36 and collected from input end Vin and outputs it to a pixel unit 20 at output end Vout, From FIG. 2, the scan line driver 18 sends a turn-on voltage through the scan line 24 to the transistor 22. As the transistor 22 turns on, the data line driver 14 transmits the required 6-bit digital image data to each pixel unit 20 charging storage capacitor Cs to a required analog voltage value to drive the liquid crystal material in the pixel unit to control the amount of passing light. After the pixel unit 20 at the last line is finished charging the scan line driver 18 cycles back to recharge from the first line. An LCD with a 60 Hz refresh frequency will achieve a display time per frame of about 1/60=16.67 ms. In other words, the scan line driver 18 will recharge each line approximately every 16.67 ms. The storage capacitors Cs are utilized to maintain the voltage difference as the transistor 22 is turned off until the corresponding transistor 22 turns on again.

As an example, there are 1536 (512*3) pixel units 20 on each line of a color LCD display. Each pixel unit 20 is electrically coupled to an output circuit formed by a DAC 36 and an OP buffer 38. A data line driver has 192 DACs 36 and 192 OP buffers 38, therefore eight data line drivers are required to control 1536 pixel units 20. In general, output of an OP buffer 38 is called a channel.

It is important for most portable device using LCD panels, such as notebook computers, to reduce power consumption. Various electrical devices utilize different types of LCD panels with various resolutions, (e.g., the number of the pixel units for each row is not identical), e.g. 1536 or 1440 pixel units for each row. Moreover, each typical data line driver, for example, controls 192 channels. If the LCD panel has 1440 pixel units for each row and is driven by the typical data line driver some of the channels (192*8−1440=96) controlled by the data line driver are not utilized resulting in extra power consumption. Please refer to FIG. 3, even when output end Vout of an OP buffer 38 is not electrically connected to a pixel unit 20 (i.e., the OP buffer 38 is not utilized for buffering analog voltage transformed by the DAC), as the transistor turns on a bias current flows through a route from Vdd to Vss causing power consumption. Reducing the power consumption of the OP buffers 38 not utilized facilitates power savings.

### SUMMARY OF INVENTION

It is therefore the objective of the claimed invention to provide a flat type display capable of switching off part of the OP buffers not utilized to reduce power consumption.

According to the claimed invention, a method of power savings for a display driver comprises: (a) selecting a register that will not store image data based on a mode signal; and (b) switching off buffers corresponding to the selected register in step (a).

According to the claimed invention, a driver for driving a display panel comprises: a plurality of registers for temporarily storing an image data; and a first mode selecting unit for selecting at least one register that will not be utilized to store the image data.

According to the claimed invention, a driver for driving a display device comprises: a first register, a second register, and a first switch coupled to the first register and the second register utilized for controlling the transfer of an image data.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows a functional block diagram of a conventional LCD display.

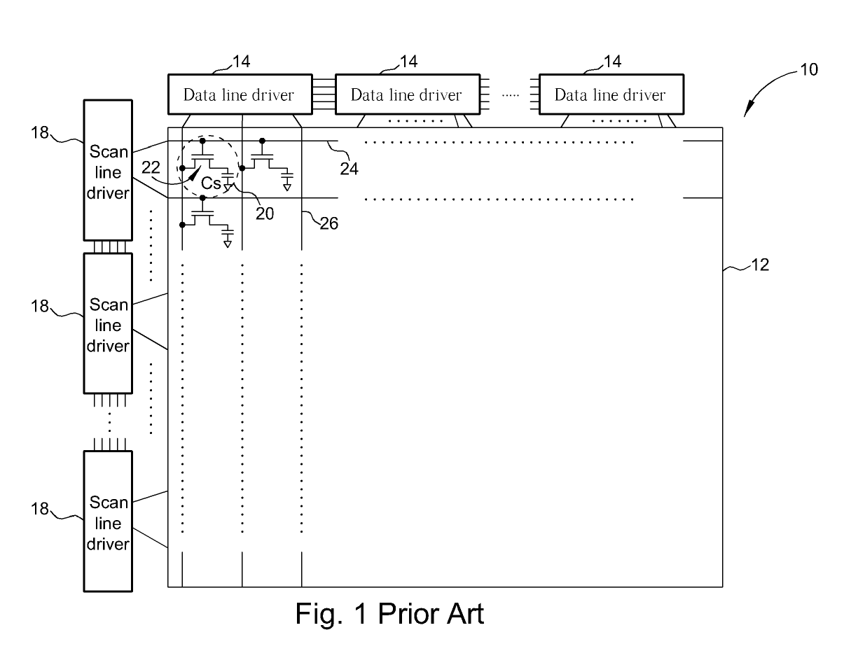

FIG. 2 is a functional block diagram of an LCD driver illustrated in FIG. 1.

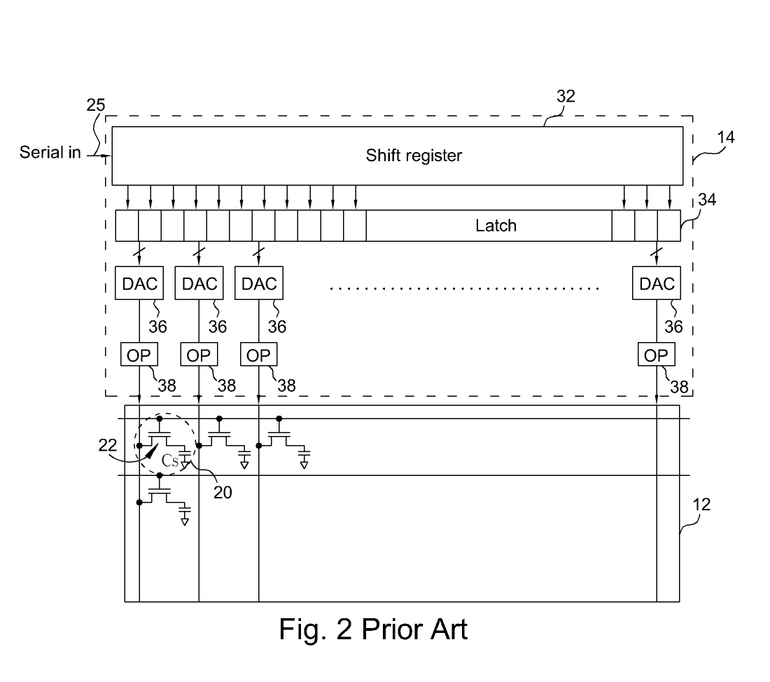

FIG. 3 is a circuit diagram of an operational amplifier buffer.

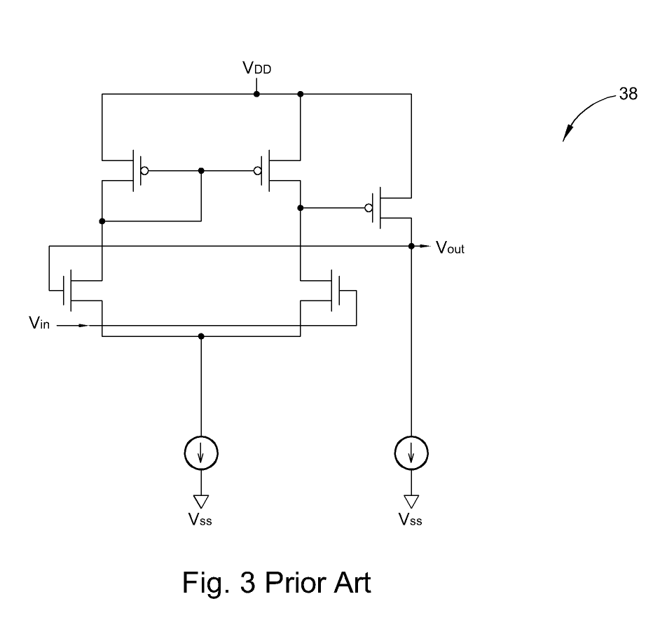

FIG. 4 shows a functional block diagram of a LCD display according to the present invention.

FIG. 5 shows a functional block diagram of the data line driver depicted in FIG. 4.

FIG. 6 shows a logic circuit diagram of the bus, the shift registers, and the mode selecting logic depicted in FIG. 5.

FIG. 7 is a circuit diagram of the OP buffer depicted in FIG. 5.

FIG. 8 shows a block diagram of a second embodiment of the flat type display according to the present invention.

### DETAILED DESCRIPTION

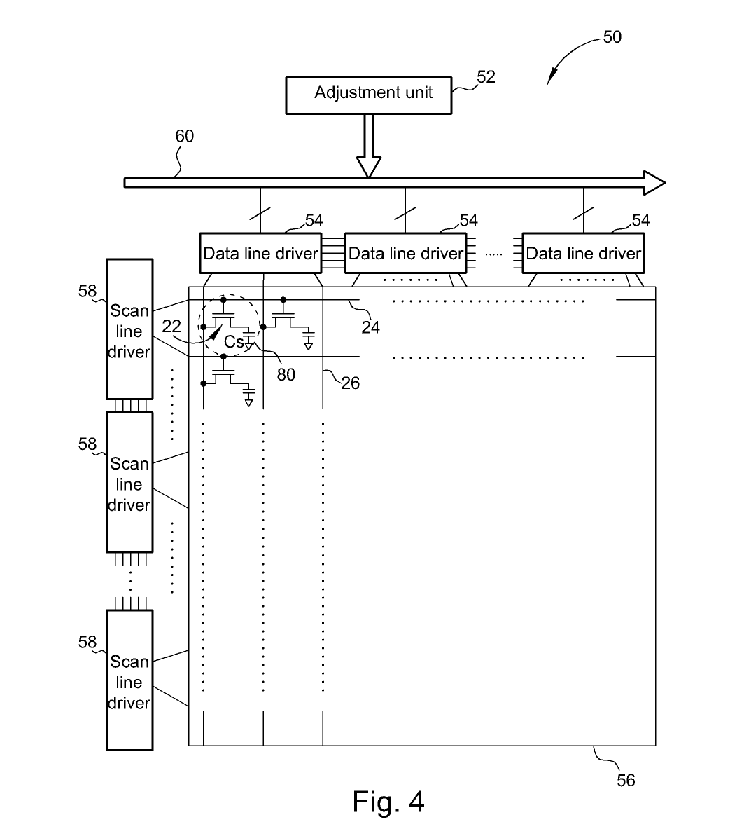

Please refer to FIG. 4, which shows a functional block diagram of an LCD display 50 according to the present invention. The LCD display 50 comprises an adjustment unit 52, a plurality of data line drivers 54, a plurality of scan line drivers 58, and an LCD panel 56. The LCD panel 56 contains a plurality of pixel units 80 to display an image. Each scan line driver 58 and each data line driver 54 control a regular number of pixel units 80. If a number of pixel units for each row is desired to change then the adjustment unit 52 outputs a mode signal to the bus 60 to control the data line drivers 54. The data line drivers 54 can adjust a number of channels based on the mode signal. For example, an LCD panel 56 having a number 1440 (480*3 (RGB)) pixel units 80 for each row, has a maximum number of channels for each data line driver 54 of 192. That means an amount of channels of eight data line drivers 54 is 1536, which includes 96 (i.e., 1536−1440) redundant channels. If 96 channels can be switched off then the LCD display 50 can reduce power consumption.

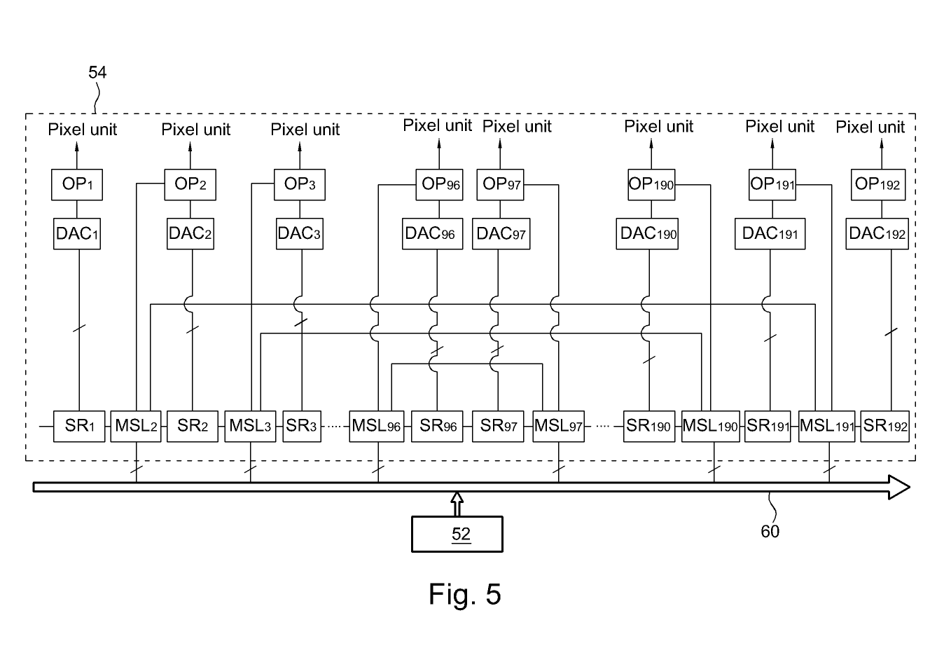

Please refer to FIG. 5, which shows a functional block diagram of the data line driver 54 depicted in FIG. 4. Suppose that each data line driver 54 controls 192 channels, and eight data line drivers 54 control 1536 channels. Using one data line driver 54 as illustration, the data line driver 54 comprises a plurality of shift registers SR1, SR2, . . . , SR191, SR192, each being electrically coupled to a digital-to-analog converter (DAC). Each DAC is electrically coupled to an operational amplifier buffer (OP buffer). Additionally, each mode selecting logic (MSL) is coupled to an OP buffer for controlling on and off switching of the OP buffer to achieve power savings. Please note that each shift register illustrated in FIG. 5 is composed of a plurality of serial-connected D flip-flops. A shift register, for instance, has 6 D flip-flops and is utilized for holding 6-bit digital image data. The DAC can transform the 6-bit digital image data into an analog voltage value. A mode selecting logic (labeled as MSL2-MSL191) is coupled between two adjacent shift registers. Note that the mode selecting logic MSL2 is also coupled to the mode selecting logic MSL191, the mode selecting logic MSL3 is also coupled to the mode selecting logic MSL190, and so on (i.e., the mode selecting logic MSL(n+1) is also coupled to the mode selecting logic MSL(192−n)). When the data line driver 54 adjusts a number of control channels from 192 to 180, the adjustment unit 52 outputs a mode signal to the data line driver 54 via the bus 60. The mode selecting logic, based on the received mode signal, determines whether to transfer the digital image data from the previous shift register to the next shift register and if a power down (i.e., turn off) signal will be output to a corresponding OP buffer. In this embodiment, two adjacent mode-selecting logics are also electrically connected to each other but for clarity this relation is not illustrated in FIG. 5.

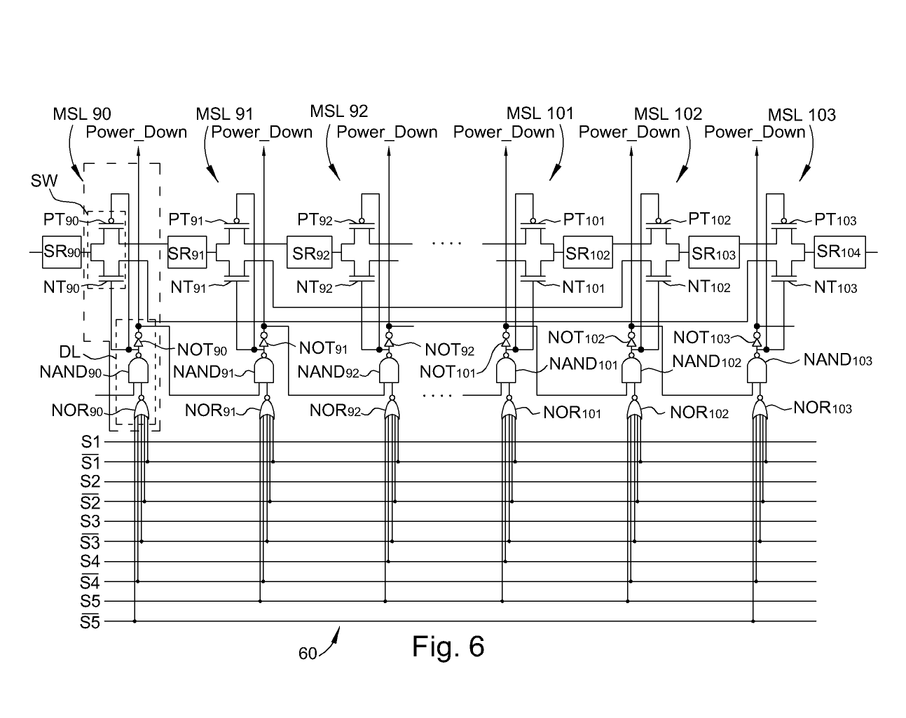

Please refer to FIG. 6 in conjunction to FIG. 5. FIG. 6 shows a logic circuit diagram of the bus, the shift registers, and the mode selecting logic depicted in FIG. 5. Each mode selecting logic comprises a switch SW and a decision logic DL. The decision logic DL comprises a NOT gate, a NAND gate, and a NOR gate. The input of the NOR gate is connected to output of the bus 60 controlled by the adjustment unit 52. An input of the NAND gate is connected with output of a NOR gate and output of previous decision logic DL. The switch SW comprises a PMOS transistor PT and an NMOS transistor NT. The PMOS transistor PT is utilized for controlling a data transfer between two adjacent shift registers and the NMOS transistor NT is utilized for controlling a data transfer between a shift register and another assigned shift register. As an example, the NMOS transistor NT( n+1) of the mode selecting logic MSL(n+1) is utilized for controlling a data transmission between the shift registers SRn and SR(192−n), and the PMOS transistor PT(n+1) of the mode selecting logic MSL(n+1) is utilized for controlling a data transmission between the shift registers SRn and SR(n+1). By an adjustment of wire layout, the NMOS transistor NT(n+1) of the mode selecting logic MSL(n+1) can also be utilized for a data transmission between the shift register SRn and the shift register SR(192−n) or between the shift register SRn and the shift register SR(97−n). As shown in FIG. 6, a data transmission between the shift registers SR89 and SR104 is controlled by the NMOS transistors NT90, NT103, a data transmission between the shift registers SR90, and SR103 is controlled by the NMOS transistors NT91, NT102. Furthermore, input of NOR gate NORn of the mode selecting logics MSLn is identical to input of NOR gate NOR(193−n) of the mode selecting logic MSL(193−n). In FIG. 6, output of the signal ends S1˜S5 are reversed to those of signal ends \overline{S1}˜\overline{S5}. The NOR gates NOR91, NOR102 are both connected to signal ends \overline{S1}\overline{S2}\overline{S3}\overline{S4}S5, the NOR gates N0R90, NOR103 are both connected to signal ends \overline{S1}\overline{S2}\overline{S3}\overline{S4S5}, and the NOR gates NOR92, NOR101 are both connected to signal ends \overline{S1}\overline{S2}\overline{S3}S4S5.

To explain the operation principle among a switch SW, a decision logic DL and associated shift registers SR, suppose that a number of pixel units 80 controlled by a data line driver declines from 192 to 180. At that moment, the adjustment unit 52 outputs a mode signal \overline{S1}\overline{S2}\overline{S3}\overline{S4}S5=00001, and outputs of NOR gates NOR91, NOR102 are logic “0”. Outputs of NOR gates NOR1-NOR90 and NOR103-NOR192 are all logic “1”.

Please note that logic “1” and logic “0” respectively correspond to a high voltage level and a low voltage level hereinafter. Because input of NAND gate NAND90 is logic “1” (i.e. output of NAND89 is logic “0”) and output of NOR gate NOR90 is logic “1”, output of NAND gate NAND90 is logic “0”. That inputs of NAND gate NAND91 are logic “1” (from output of NAND gate NAND 90 and the inverter) and logic “0” (from input of NOR gate NOR91) concludes logic “1” of output of NAND gate NAND91. The NAND gates NAND102, NAND103 have the same logic situation as the NAND gate NAND91. Because output of NAND gate NAND91 is logic “1”, logic “0” is obtained via the inverter. And because result of the output of the NAND gate NAND91 through the inverter is an input to the NAND gate NAND92, regardless of the output of NOR gate NOR92, the output of NAND gate NAND92 must be logic “1”. That is, once output of the NAND gate NAND91 is logic “1”, outputs of the following NAND gates NAND92-NAND96 are all logic “1”. Similarly, as output of the NAND102 is logic “1”, outputs of the NAND gates NAND97-NAND101 are all logic “1”. Output of NAND gate of NAND90 being logic “0” drives the PMOS transistor PT90 conducting, relatively, the NMOS transistor NT90 is not conducted, so that the digital data of the shift register SR89 can transfer to the shift register SR90 via the PMOS transistor PT90. However, logic “1” from the NAND91 drives the NMOS transistor NT91, on the contrary, the PMOS transistor PT91 is switch off, so that the digital image data of the shift register SR90 will pass to the shift register SR103 through the NMOS transistors NT91, NT102. Through the above mechanism, the digital data in shift register SR103 will transfer to the next shift register SR104. Consequently, from FIG. 5, the mode selecting logics MSL91-MSL102 will not store digital image data in the shift registers SR91-SR102. That is the digital image data will be stored in the shift registers SR1-SR192 but not the shift registers SR91-SR102.

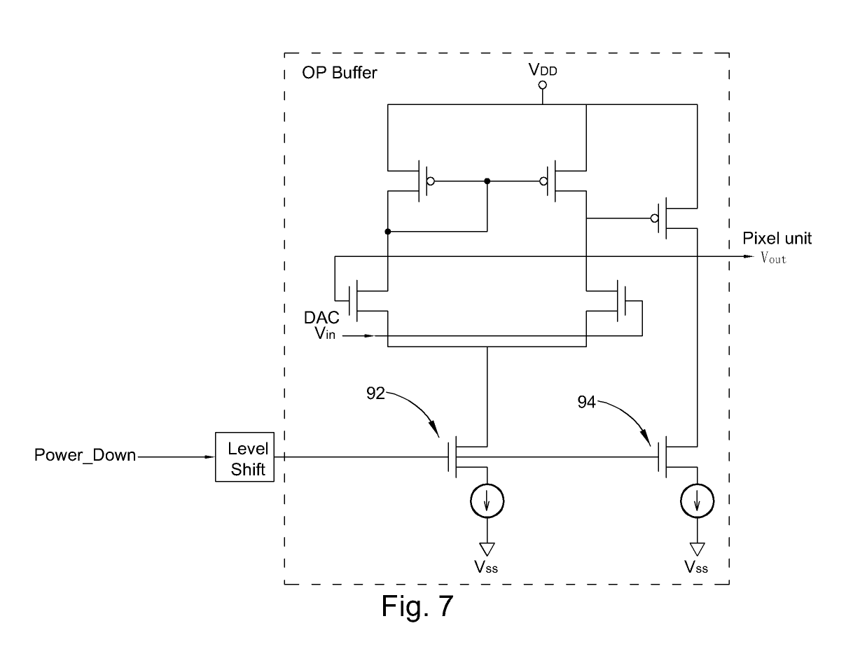

Please refer to FIG. 7 in conjunction to FIG. 6. FIG. 7 is a circuit diagram of the OP buffer depicted in FIG. 5. In FIG. 7, an input end Vin of the OP buffer is electrically connected to output of the DAC, an output end Vout of the OP buffer is electrically connected to the pixel unit 80, the Power_Down end is electrically connected to output of a mode selecting logic MSL (i.e. output of a decision logic DL) depicted in FIG. 6. Using the mode selecting logic MSL90 and the mode selecting logic MSL91 and its corresponding OP buffer as an illustration. As previously mentioned, a high level voltage, serves as logic “1”, it is output by the mode selecting logic MSL90 and switches on the transistors 92, 94. Meanwhile, the DAC 90 transforms the digital image data from the shift register SR90 into an analog voltage and transfers it to input end Vin of the OP buffer OP90. The OP buffer OP90 buffers the analog voltage and sends it to the corresponding pixel unit 80 via output end Vout, so that the pixel unit 80 can display a brightness based on the analog voltage. On the contrary, as the mode selecting logic MSL91 outputs logic “0” (i.e. a low level voltage) to the transistors 92, 94 to switch off them, the transistor of the OP buffer OP91 does not work and no bias current flows on a route from Vdd to Vss, reducing extra power consumption.

Through the above-mentioned mechanism, the digital image data will not transfer to shift registers SR91-SR102, and transistors of the OP buffers OP91-OP102 corresponding to shift registers SR91-SR102 does not turn on, thereby, reducing power consumption.

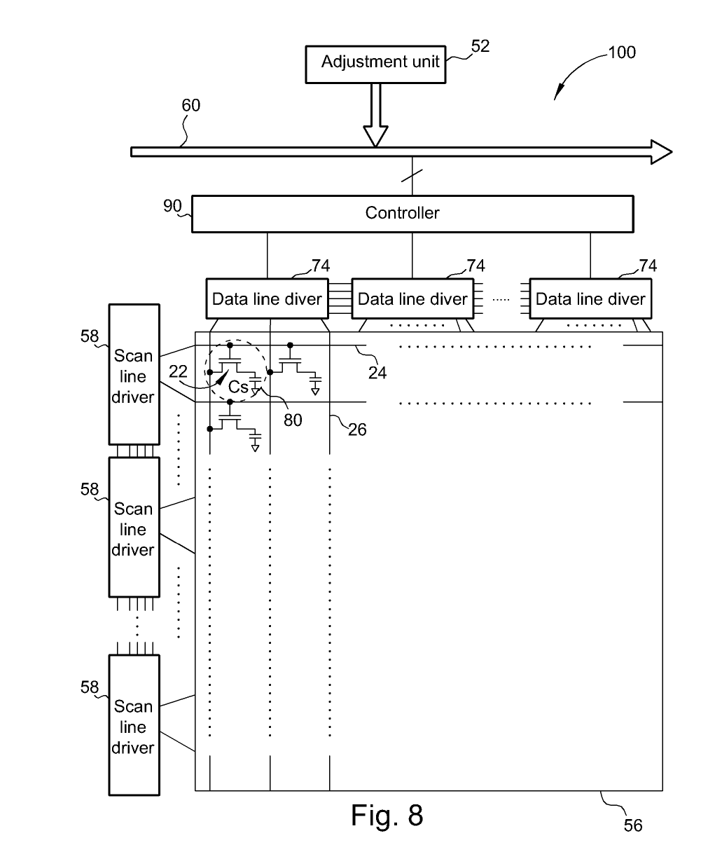

Please refer to FIG. 8, which shows a block diagram of a second embodiment of the flat type display 100 according to the present invention. Different from the previous embodiment, the flat type display 100 of this embodiment further comprises a controller 90 not to be integrated in the data line driver 74, which has similar functions or structure to the decision logic illustrated in FIG. 6. Therefore, the controller 90, based on the mode signal from the adjustment unit 52, selects which shift registers are not utilized for holding the digital image signals and will switch off the power routes of the OP buffers corresponding to the selected shift registers.

In these first and second embodiments of the present invention, the adjustment unit 52 can be ignored and directly set the signal ends S1 through S5 of the bus to an assigned voltage level (e.g., logic “0” or “1”) so as to define the mode signal. For example, the signal ends S1, S2 are grounded (logic “0”) and the signal ends S3-S5 are electrically connected to Vcc (logic “1”). This does not require the adjustment unit to output a mode signal.

The present invention data line driver can selectively switch off parts of channels according to various display resolutions. Additionally, the flat panel type display can be a Thin Film Transistor Liquid Crystal Display (TFT-LCD) or a Liquid Crystal on Silicon (LCOS) display.

A number of pixel units for each row is standardized, for example, conventional LCD panels have several standards such as: 1536, 1400, or 1280 pixel units per each row. The data line driver also controls a standardized number of channels, for example, 192. If the number of 8 data line drivers each having 192 channels are assembled into an LCD display having 1400 pixel units for each row, part of the OP buffers controlled by each data line driver can be switched off to reduce power consumption. In contrast to prior art, the present invention LCD driver sets mode selecting logics between shift registers to switch off some OP buffers corresponding to the shift registers that will not be utilized to store digital data, based on a number of pixel units for each row of a LCD panel, thereby reducing power consumption.

Additionally, it is not necessary to arrange a mode selecting logic MSL for each channel. The developer can arrange several mode-selecting logics in a data line driver, which one mode selecting logic can control simultaneously control multiple channels. Certainly, it is not essential, as shown in FIG. 6, that output of a previous decision logic DL is needed as input of the next decision logic DL.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of power savings for a display driver comprising:
(a) selecting at least a register not to store image data based on a mode signal; and
(b) shutting down buffers corresponding to the selected register in step (a).

2. The method of claim 1 further comprising:
(c) feeding the image data into non-selected registers in step (a).

3. The method of claim 2 further comprising:
(d) sending the image data stored in the non-selected registers in step (a) to a digital-to-analog converters corresponding to the non-selected registers in step (a).

4. The method of claim 3 further comprising:
(e) driving a display device by using the analog image signal from the digital-to-analog converters in step (d).

5. The method of claim 1 wherein the register is a shift register.

6. The method of claim 1 wherein the display driver is used for a liquid crystal display panel.

7. A driver for driving a display panel comprising:
a plurality of registers for temporarily storing an image data; and
a first mode selecting unit for selecting at least a register not to be stored the image data.

8. The driver of claim 7 further comprising:
a plurality of digital-to-analog converters for transforming the image data from the plurality of registers into analog image data; and
a plurality of buffers for outputting the analog image data from the digital-to-analog converters to the display panel to display an image;
wherein at least one of the buffer is switched off based on the first control signal from the first mode selecting unit.

9. The driver of claim 7 further comprising:
a switch between two registers controlled by the first mode selecting unit.

10. The driver of claim 7 further comprising:
a bypass, coupled to two registers which are not adjacent to one other, for transferring the image data.

11. The driver of claim 10 further comprising:
a switch disposed in the bypass controlled by the first mode selecting unit.

12. The driver of claim 7 being utilized for driving a liquid crystal display panel.

13. The driver of claim 8 further comprising:
a second mode selecting unit for producing a second control signal in response to a first control signal, switching off one or more of the buffers based on the second control signal.

14. The driver of claim 7, wherein the registers are shift registers.

15. A driver for driving a display device comprising:
a first register;
a second register; and
a first switch, coupled to the first register and the second register, for controlling a transfer of a digital image data.

16. The driver of claim 1 5 further comprising:
a buffer coupled to the second register, a power route of the buffer being switched off as the first switch is switched off.

17. The driver of claim 16 further comprising:
a second switch coupled to the first register, the second switch being switched on as the first switch is switched off, so as to control transfer of the digital image data.

18. The driver of claim 15, wherein the display device is a liquid crystal display panel.

19. The driver of claim 15, wherein the first register is a shift register.
